(19) United States
(12) Patent Application Publication
(10) Pub. No.: US 2005/0045023 A1
(43) Pub. Date: Mar. 3, 2005

(54) Animated flute

(76) Inventor: Cheng-Yong Chen, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/646,789

(22) Filed: Aug. 25, 2003

(51) Int. Cl. G10D 7/02

(52) U.S. Cl. 84/384

(57) ABSTRACT

An animated flute includes an animated air bag at one end of a pipe. The air bag has an air passage connected to the pipe and an air outlet. When air is blown into the air bag through the air passage, the air bag is inflated and the animated figure can be seen clearly.

### FIELD OF THE INVENTION

This invention relates to a flute, and more particularly to an animated flute design.

### BACKGROUND OF THE INVENTION

A flute has been on the market for many years, in particular to the sound of the flute attracts many people to their childhood memory.

As shown in FIG. 3, a conventional flute comprises a flute A with a folded paper B connected to one end of the flute A. The paper B is embedded with steel wire C, which is in a swirl shape. The paper B comprises an air outlet B1 at one end. When blowing the flute from a reed A1, the air flats the paper B to a straight shape while making a sound. Once the air is gone, the steel wire C brings the paper B back to its original position. This design is tedious and less attractive.

In view of this and many others, the inventor has derived the present invention to attract consumers' attention.

### SUMMARY OF THE INVENTION

It is the primary object of the present invention to provide an animated flute, which has an animated figure to attract consumers.

It is another object of the present invention to provide an animated flute, which is inexpensive in manufacture.

### BRIEF DESCRIPTION OF THE DRAWINGS

FIG. 1 is a perspective view of a first embodiment of the present invention;

FIG. 2 is a perspective view of a second embodiment of the present invention, and

FIG. 3 is a perspective view of a prior art.

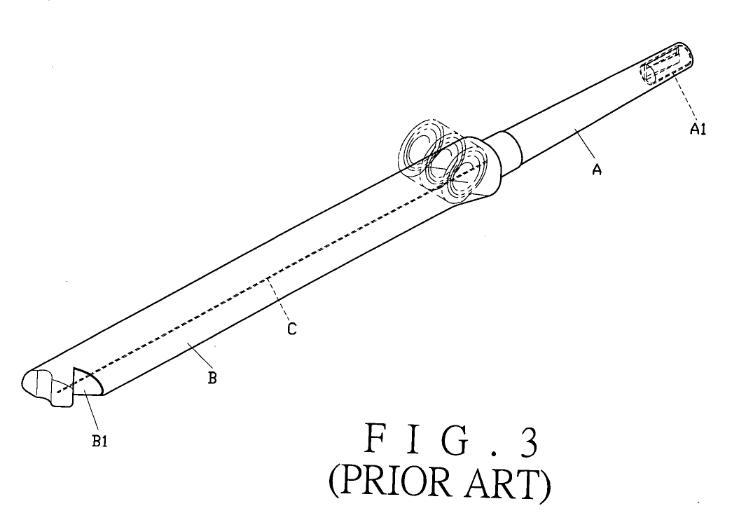

### DETAILED DESCRIPTION OF THE PREFERRED EMBODIMENTS

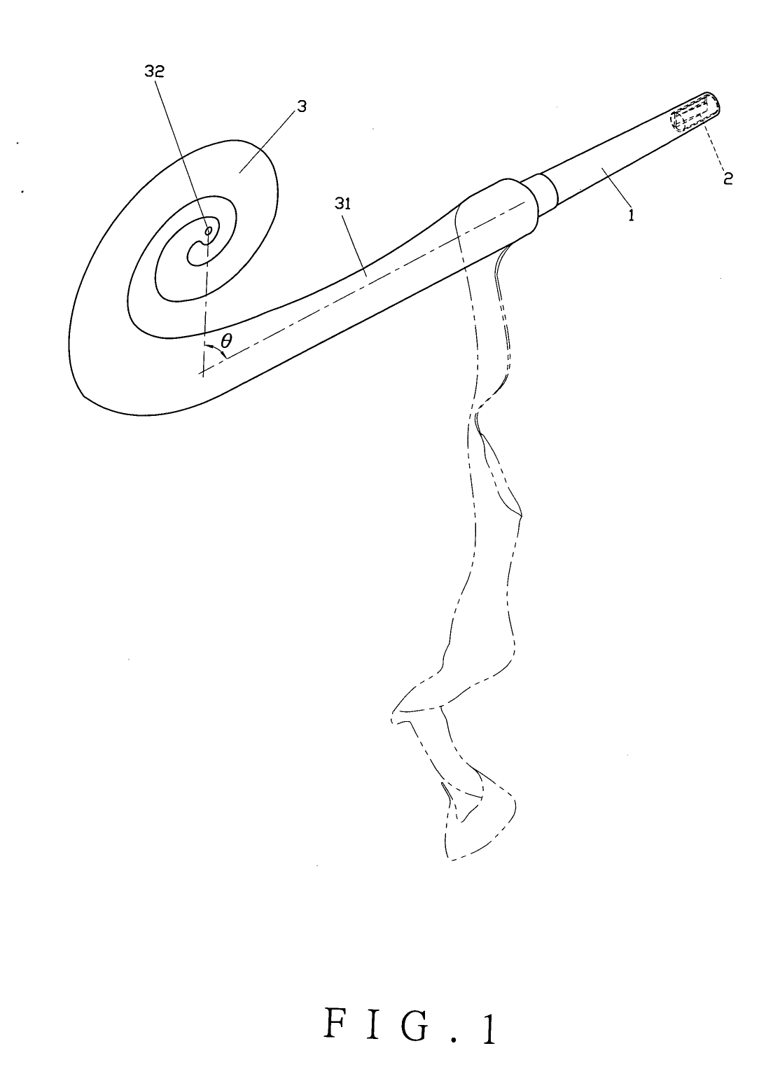

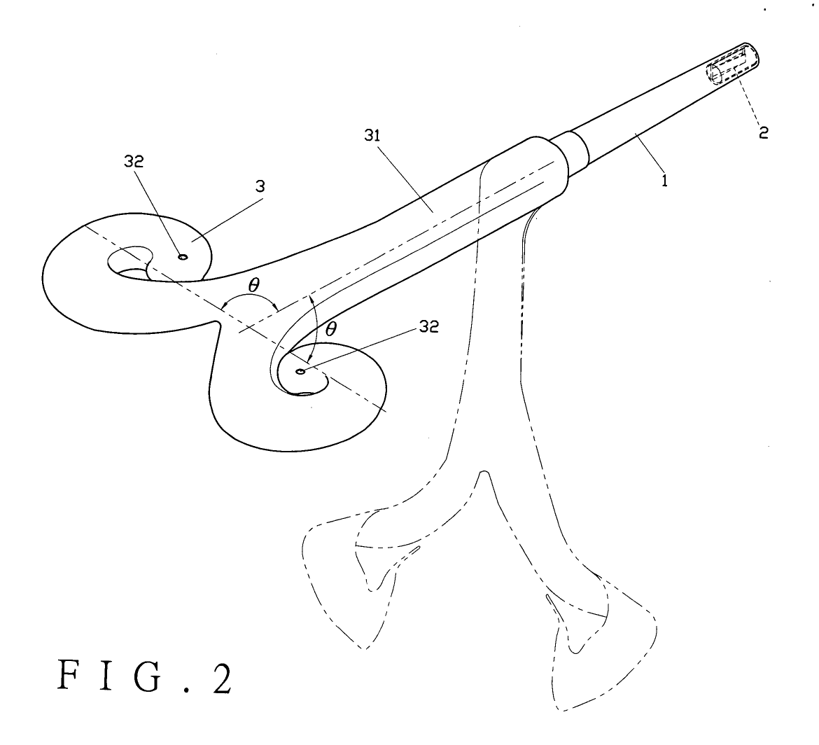

As shown in FIGS. 1 and 2, the present invention comprises a pipe 1 with a reed 2 at one end and an animated air bag 3 connected to the other end of the pipe 1. The air bag 3 has an air passage 31 and an air outlet 32 thereon. The air bag 3 is made of plastic material, which is in a flat position without air and is in an inflated situation when air is blown therein.

When air is blown into the air bag 3 from the reed 2 through the pipe 1 and the air passage 31, the air bag 3 is inflated with air inside and the animated feature presents an attractive toy to consumers. When the air in the air bag 3 is released, the air bag 3 will flat again. The air passage 31 may be in a straight or curved shape.

The air bag 3 and the air passage 31 are connected at a “θ” degree due to the air bag 3 and the air passage 31 are in different directions. It exists a time differential of inflation of the air bag 3, thus the air bag 3 is more vivid image.

In view of the above description of the animated flute of the present invention, it is obvious that the present invention corresponds to the novelty of an invention.

1. An animated flute comprising an air bag which is made to an animated shape and being secured to one end of said flute through an air passage, and said air bag comprising at least one air outlet.

2. The animated flute, as recited in claim 1, wherein said air passage is in a straight shape.

3. The animated flute, as recited in claim 1, wherein said air passage is in a curved shape.

4. The animated flute, as recited in claim 1, wherein said air bag and said air passage are in different directions.
